(19) United States
(12) Patent Application Publication
(10) Pub. No.: US 2009/0242651 A1
(43) Pub. Date: Oct. 1, 2009

(54) Local Comfort Zone Control

(75) Inventors: Wai-leung Ha, Hong Kong (CN); Kairy Kai Lei, Shen Zhen City (CN); Robert Vincent Chou, Louisville, KY (US)

Correspondence Address: BANNER & WITCOFF, LTD., TEN SOUTH WACKER DRIVE, SUITE 3000, CHICAGO, IL, 60606, US

(73) Assignee: Computime, Ltd., Wanchai (HK)

(21) Appl. No.: 12/059,442

(22) Filed: Mar. 31, 2008

(51) Int. Cl. G05D 23/19

(52) U.S. Cl. 236/51

(57) ABSTRACT

The present invention supports the remote control of an environmental unit based on an effective temperature that is indicative of a comfort index to an occupant of a controlled environmental space. The remote controller obtains a plurality of environmental factors, e.g., temperature, relative humidity, and air speed, in order to determine an effective temperature. When the effective temperature is sufficiently different from a set point temperature, the remote controller activates an environmental unit to change the effective temperature in accordance with the set point temperature. The environmental unit may include an air conditioner, furnace, or heat pump. Also, the remote controller may communicate with at least one remote sensor over a wireless communications channel in order to obtain the environmental factors for determining the effective temperature.

### BACKGROUND OF THE INVENTION

A heating ventilation and air conditioning (HVAC) system is typically controlled based on temperature measurements. By comparing the ambient measured temperature and the set point temperature, a heating or air conditioning system is activated or deactivated in order to regulate the room temperature. However, such a system is not really energy efficient for several reasons. First, only temperature is considered. Second, the temperature is typically measured on a wall and not close to the occupants.

Systems may also display other types of environmental factors but not utilize those environmental factors when controlling an air conditioner or furnace. Thus, there is a real market need to provide an environmental control that better reflects the degree of comfort to an occupant.

### SUMMARY OF THE INVENTION

The present invention provides apparatuses and computer readable media for remotely controlling an environmental unit based on an effective temperature that is indicative of a comfort index.

With another aspect of the invention, a remote controller obtains a plurality of environmental factors in order to determine an effective temperature. When the effective temperature is sufficiently different from a set point temperature, the remote controller activates an environmental unit to change the effective temperature in accordance with the set point temperature. The environmental unit may include an air conditioner, furnace, heat pump, humidifier, and/or de-humidifier.

With another aspect of the invention, a remote controller controls a heating unit when the effective temperature is sufficiently less than a set point temperature. The effective temperature is determined from relative humidity and temperature measurements. The remote controller activates a humidifier until the effective temperature is sufficiently increased with respect to the set point temperature or until a measured relative humidity is sufficiently stable. When the effective temperature cannot be sufficiently increased by activating the humidifier, the remote controller activates the heating unit until the effective temperature is sufficiently increased with respect to the set point temperature.

With another aspect of the invention, a remote controller controls a cooling unit when the effective temperature is sufficiently greater than the set point temperature. The effective temperature is determined from relative humidity, temperature, and air speed measurements. With one embodiment, a remote controller activates a fan until the effective temperature is sufficiently decreased with respect to the set point temperature or until the fan reaches a maximum fan speed. When the effective temperature cannot be sufficiently decreased by activating the fan, the remote controller activates the de-humidifier until the effective temperature is sufficiently decreased with respect to the set point temperature or until the de-humidifier reaches a maximum de-humidifier speed. When the effective temperature cannot be sufficiently decreased by activating the fan and the de-humidifier, the remote controller activates the cooling unit until the effective temperature is sufficiently decreased with respect to the set point temperature. With another embodiment, a remote controller activates a de-humidifier until effective temperature is sufficiently decreased with respect to the set point temperature or until the de-humidifier reaches a maximum de-humidifier speed. When the effective temperature cannot be sufficiently decreased by activating the de-humidifier, the remote controller activates the fan until the effective temperature is sufficiently decreased with respect to the set point temperature or until the fan reaches a maximum fan speed. When the effective temperature cannot be sufficiently decreased by activating the fan and the de-humidifier, the remote controller activates the cooling unit until the effective temperature is sufficiently decreased with respect to the set point temperature. With another embodiment, a remote controller activates a de-humidifier and the fan until effective temperature is sufficiently decreased with respect to the set point temperature or until the de-humidifier reaches a maximum de-humidifier speed and the fan reaches a maximum fan speed. When the effective temperature cannot be sufficiently decreased by activating the fan and the de-humidifier, the remote controller activates the cooling unit until the effective temperature is sufficiently decreased with respect to the set point temperature.

With another aspect of the invention, a remote controller communicates with remote sensors over a wireless communications channel. The remote controller may establish a wireless communications channel to the remote sensors using a wireless protocol, e.g., ZigBee or Z-Wave.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a remote controller controlling a plurality of controlled devices in accordance with an embodiment of the invention.

FIG. 2 shows a flow diagram for a remote controller when controlling a cooling unit in accordance with an embodiment of the invention.

FIG. 3 shows a flow diagram for a remote controller when controlling a cooling unit in accordance with an embodiment of the invention.

FIG. 4 shows a flow diagram for a remote controller when controlling a cooling unit in accordance with an embodiment of the invention.

FIG. 5 shows a flow diagram for a remote controller when controlling a heating unit in accordance with an embodiment of the invention.

### DETAILED DESCRIPTION

A remote controller controls an environmental unit (e.g., a cooling unit or a heating unit) based on a comfort index. The comfort index is indicative of the effect of the temperature as perceived by an occupant in an environmental space that is cooled or heated by the environmental unit.

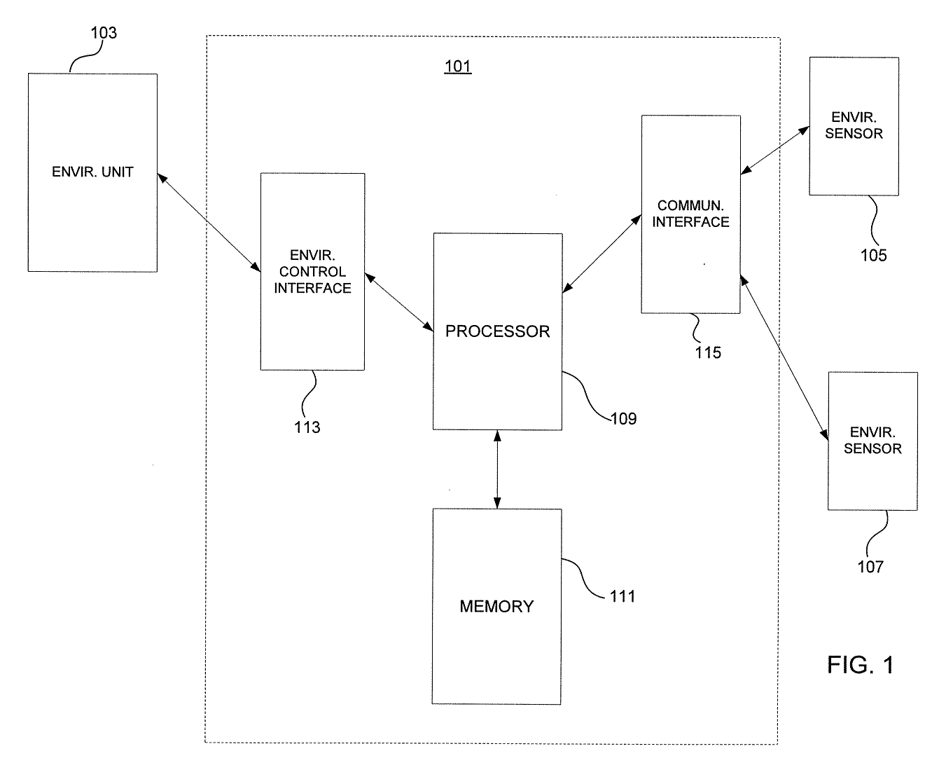

FIG. 1 shows a remote controller controlling a plurality of controlled devices in accordance with an embodiment of the invention.

The temperature felt by a person (which may be referred as the comfort index) is not usually the actual measured temperature. The sensation of temperature to a person is typically affected by the humidity and the air movement speed. In general the lower the humidity, the cooler a person feels. Also, the greater the air movement, the cooler the person feels. Aspects of the invention are based on a table (that relates an effective temperature to the measured temperature and relative humidity) and a relationship (that relates the effective temperature to air flow velocity) that are utilized by a remote controller as will be discussed.

The comfort index may be gauged by an effective temperature, which is related to the measured temperature (dry bulb) and relative humidity as shown in the following table. (The Table may be expanded for relative humidity values below 40% by using a linear extrapolation.)

TABLE
EFFECTIVE TEMPERTURE (Tₕ) AS A FUNCTION OF
HUMIDITY AND TEMPERATURE

| ° F. | | | | | | |
|---|---|---|---|---|---|---|
| Measured | RH | | | | | |
| Temp (dry | 40% | 50% | 60% | 70% | 80% | 90% |
| bulb) | Feel like temperature (Tₕ) | | | | | |
| 70 | 61 | 63 | 66 | 68 | 71 | 73 |
| 72 | 62 | 65 | 68 | 71 | 74 | 77 |
| 74 | 64 | 67 | 70 | 73 | 77 | 80 |
| 76 | 67 | 70 | 73 | 76 | 79 | 82 |
| 78 | 70 | 74 | 76 | 79 | 82 | 85 |
| 80 | 73 | 77 | 80 | 83 | 86 | 90 |

When considering only the measured temperature (T_{measured}) and the relative humidity (Hr), as shown in the Table, Tₕ is the effective temperature.

In addition, the effective temperature may be affected by the air flow by an occupant. The air flow may be affected by different environmental equipment, including ceiling fans and ventilation fans. The effective temperature (Tₑ) may be specified as a function of the dry bulb temperature, relative humidity, and the air speed as follows:

Tₑ=A₁−A₂(V^{c})+Tₕ[B+D(V^{c})] (EQ. 1)

where A₁, A₂, B, C and D are constants, Tₕ is determined from the above Table, and V is the air speed.

Integrating the temperature, humidity and air speed considerations for controlling an environmental unit based on old technologies may be difficult. However, with wireless networking technology, full control and acquisition of data from environmental sensors is viable and accurate. Embodiments of the invention utilize wireless networking components, e.g., ZigBee RF module or Z-Wave RF module, as the backbone for communication to acquire environmental information and to control the following devices in a local area, e.g., living room, bed room:
Air Conditioner
Ceiling Fan or air flow actuator
Humidifier and
De-humidifier

Environmental and system information is sent through the corresponding devices to the central comfort controller 101 in order to calculate the comfort index. Environmental and system information include:
Local temperature as measured by a remote temperature sensor installed in close proximity to the occupants of the environmental space
Humidity as measured by a humidity sensor installed in a humidifier or de-humidifier
Fan speed of a fan or air flow actuator

With information about the local temperature, humidity, and fan, the effective temperature (Tₑ) can be computed. If the effective temperature is beyond the set range configured by user, control algorithms can be used to control an environmental unit as will be discussed.

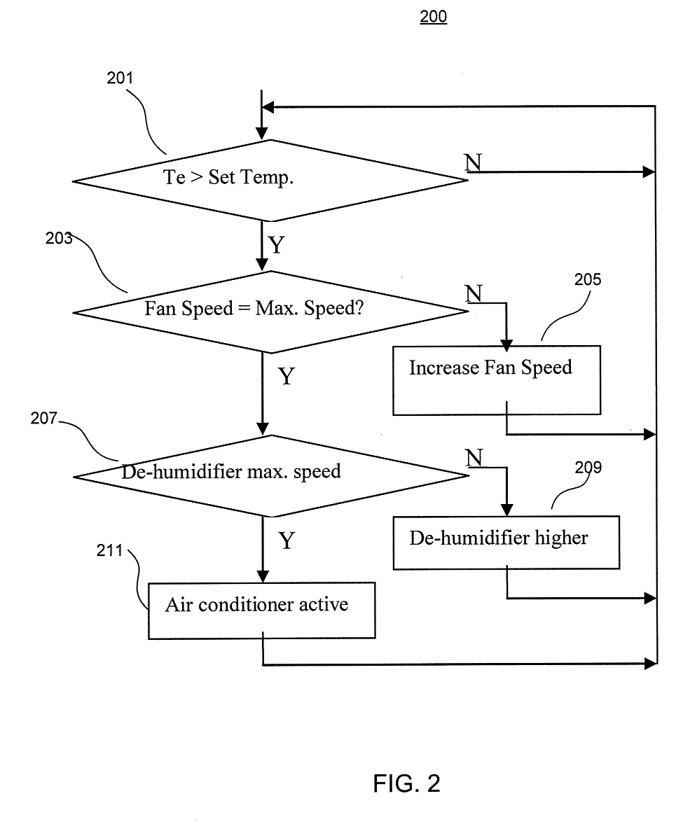

As shown in FIG. 1, remote controller 101 comprises processor 109, memory 111, environmental control interface 113, and communications interface 115. Processor 109 receives measurements of environmental factors from environmental sensors 105 and 107 through communications interface 115. Environmental sensors measure environmental factors, e.g., temperature, humidity, and air speed within an environmental space. Processor 109 processes the measured environmental factors in accordance with computer-executable instructions from memory 111 and controls environmental unit 103 through environmental control interface 113 based on the measured environmental factors in accordance with a control algorithm, e.g., flow diagrams 200-500 as shown in FIGS. 2-5.

Processor 109 obtains environmental factors from remote temperature sensors and humidity sensors (e.g., environmental sensors 105 and 107) through communications interface 115. Communications interface 115 may support different wireless technologies, e.g., ZigBee or Z-Wave, in order to establish communications between processor 109 and sensors 105 and 107. While sensors 105 and 107 may be remotely situated, environmental sensors may be located near or within remote controller 101.

Memory 111 may include different forms of computer-readable media that can be accessed by processor 109. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism. With embodiments, the above Table may be implemented as a look-up table and EQ. 1 may be implemented as a sequence of computer-executable instructions in memory 111.

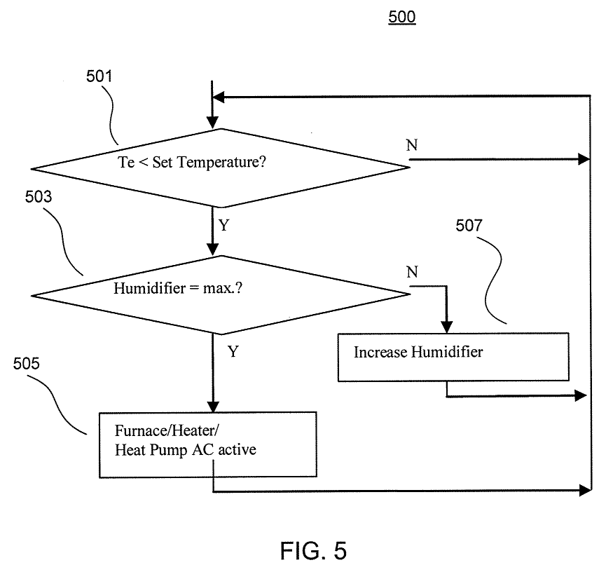

As discussed below, flow diagrams 200, 300, and 400 (as shown in FIGS. 2, 3, and 4, respectively) are associated with remote controller 101 operating in a cooling mode. Flow diagram 500, as shown in FIG. 5, is associated with remote controller 101 operating in a heating mode. With embodiments, a predetermined duration of time may be invoked before activating the heating unit or cooling units in flow diagrams 200-500.

While flow diagrams 200-500 compare the effective temperature to the set point temperature, embodiments of the invention may utilize an offset about the set point temperature in order to provide a temperature hysteresis to reduce the amount of control cycling. For example, if the set point temperature is set at 68° F. for the heating mode, remote controller 101 activates environmental unit 103 when the effective temperature is at or below 67° F. and continues activating a heating unit until the effective temperature reaches 69° F. In this example, the temperature offset is ±1° F.

FIG. 2 shows flow diagram 200 for remote controller 101 when controlling a cooling unit in accordance with an embodiment of the invention. The cooling unit may be considered a part of environmental unit 103 as shown in FIG. 1. The cooling unit may assume different forms, including an air conditioner or a heat pump.

Flow diagram 200 supports a cooling mode of operation that is used typically during the summer to cool an environmental space (e.g., a room, house, and conference area). Flow diagram 200 uses an air speed-dominated strategy. If the effective temperature Tₑ is higher than the set point temperature, the fan speed will be increased to move Tₑ down according to the above Table and EQ. 1. However, if the fan speed is reaching to its ceiling speed, the de-humidifier will be turned on to lower the effective temperature Tₑ. If the de-humidifier cannot change the effective temperature back to the set range, the air conditioner is activated.

Referring to flow diagram 200, if step 201 determines that the effective temperature is greater than the set point temperature, then step 203 determines if the fan speed is at the maximum fan speed. If not, the fan speed in increased (e.g., by a predetermined incremental speed) in step 205. If the fan speed is at the maximum fan speed, then step 207 determines if the de-humidifier is operating at maximum de-humidifier speed. (While with the exemplary embodiment, the intensity of de-humidity operation is determined by the de-humidifier speed, other embodiments may use other approaches. For example, valves may cut off sections of the de-humidifier coil to reduce the amount of refrigerants.) If not, then step 209 increases the de-humidifier speed. Otherwise, the cooling unit is activated in step 211 until the effective temperature reaches the set point temperature.

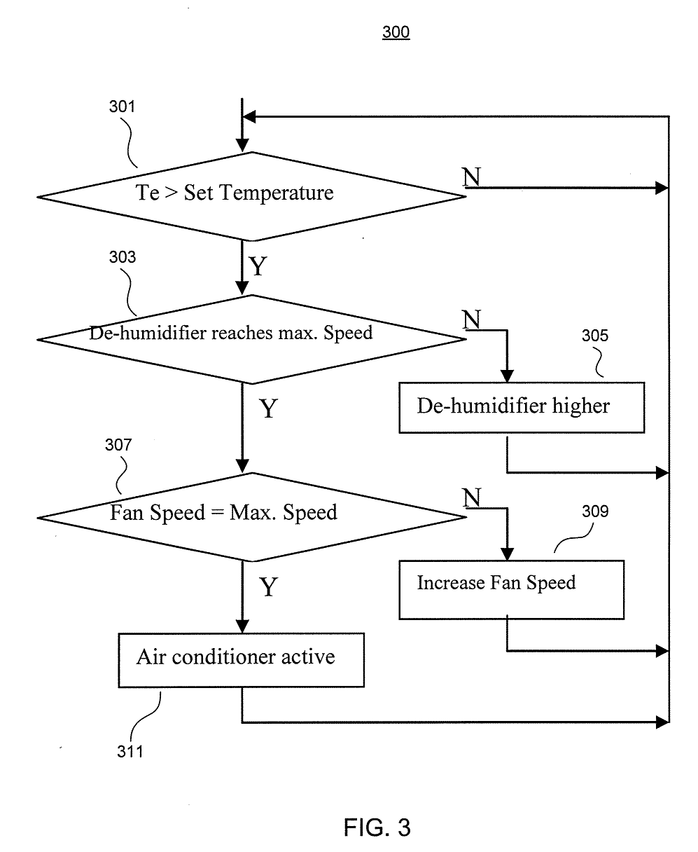

FIG. 3 shows flow diagram 300 for remote controller 101 when controlling a cooling unit in accordance with an embodiment of the invention. Flow diagram 300 uses a humidity-dominated strategy and is similar to flow diagram 200. However, the environmental system activates the de-humidifier before activating the fan.

Referring to flow diagram 300, if step 301 determines that the effective temperature is greater than the set point temperature, then step 303 determines if the de-humidifier speed is at the maximum dehumidifier speed. If not, the de-humidifier speed in increased (e.g., by a predetermined incremental speed) in step 305. If the de-humidifier speed is at the maximum de-humidifier speed, then step 307 determines if the fan is operating at maximum fan speed. If not, the step 309 increases the fan speed. Otherwise, the cooling unit is activated in step 311 so that the effective temperature reaches the set point temperature.

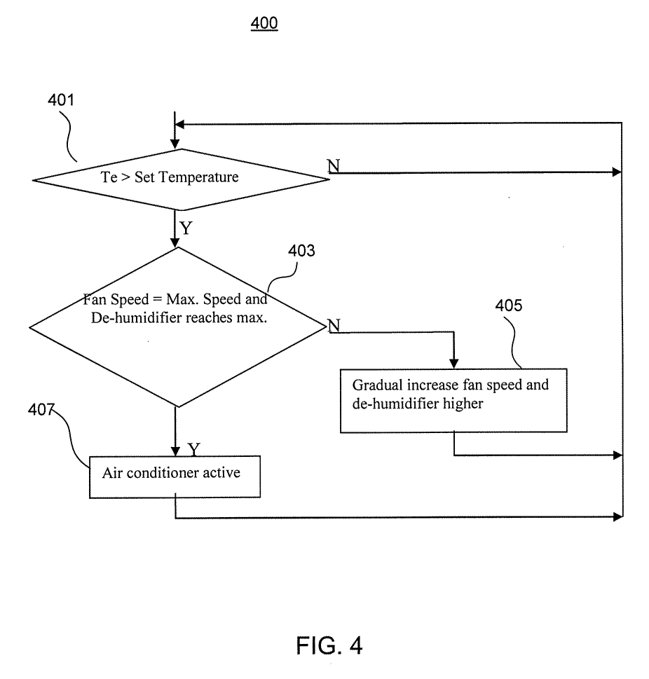

FIG. 4 shows flow diagram 400 for remote controller 101 when controlling a cooling unit in accordance with an embodiment of the invention. Flow diagram 400 utilizes a simultaneous strategy. If the effective temperature (Tₑ) is higher than set range, de-humidifier will turn on and fan speed will increase gradually. The effective temperature (Tₑ) is monitored periodically. If remote controller 101 can change the effective temperature to the set point temperature, the air conditioner is not activated. If both fan speed and de-humidifier are turned to their full speed and full-on status, respectively, but the effective temperature cannot reach the set point temperature, the air conditioner is activated.

Referring to flow diagram 400, if step 401 determines that the effective temperature is greater than the set point temperature, then step 403 determines if the de-humidifier speed and the fan speed are operating at the maximum speed. If not, the de-humidifier speed and the fan speed are gradually increased (e.g., by predetermined amounts) in step 405. If the de-humidifier and fan are operating at maximum speeds, then the cooling unit is activated in step 407 until the effective temperature reaches the set point temperature.

FIG. 5 shows flow diagram 500 for a remote controller 101 when controlling a heating unit in accordance with an embodiment of the invention. The heating unit may be considered a part of environmental unit 103 as shown in FIG. 1. The heating unit may assume different forms, including a furnace or a heat pump.

Flow diagram 500 supports a heating mode of operation that is used typically during the winter to heat an environmental space (e.g., a room, house, and conference area). Since air flow typically cools down the temperature, applying air flow (air speed) is not applicable to the heating mode. Consequently, only temperature and humidity is considered for the heat mode. In flow diagram 500, humidity has priority because the humidifier typically requires less energy than an air conditioner. If the effective temperature (Tₑ) is lower than the set point temperature, the humidifier is activated. If the environment reaches the effective temperature, the humidifier is deactivated. When the relative humidity drops below a predefined tolerance, e.g., 3%, the humidifier is re-activated. If the measured relative humidity is determined to be stable for a predefined period of time but the effective temperature is not elevated to the set point temperature, the heat pump or furnace is activated in order to increase the effective temperature.

Referring to flow diagram 500, if step 501 determines that the effective temperature is less than the set point temperature, then step 503 determines if the humidifier speed is at the maximum humidifier speed. If not, the humidifier speed in increased (e.g., by a predetermined incremental speed) in step 507. If the humidifier speed is at the maximum humidifier speed, then step 505 activates the heating unit (furnace, heater, or heat pump).

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a memory;
a processor coupled to the memory and configured to perform:
(a) obtain a plurality of environmental factors
(b) determine an effective temperature from the plurality of environmental factors; and
(c) when the effective temperature is sufficiently different from a set point temperature, activate an environmental unit to change the effective temperature in accordance with the set point temperature.

2. The apparatus of claim 1, wherein the environmental unit comprises a heating unit and a humidifier, and wherein the processor is further configured to:
(d) when the effective temperature is sufficiently less than the set point temperature, activate the heating unit and the humidifier.

3. The apparatus of claim 2, wherein the plurality of environmental factors include a temperature measurement and a relative humidity measurement, wherein the processor is further configured to:
(e) determine the effective temperature from the temperature measurement and the humidity measurement;
(f) activate the humidifier until the effective temperature is sufficiently increased with respect to the set point temperature or until a measured relative humidity is sufficiently stable; and
(g) when the effective temperature cannot be sufficiently increased by activating the humidifier, activate the heating unit until the effective temperature is sufficiently increased with respect to the set point temperature.

4. The apparatus of claim 3, wherein the processor is further configured to:
(h) when the measured relative humidity drops below a predetermined tolerance, re-activate the humidifier.

5. The apparatus of claim 1, wherein the environmental unit comprises a cooling unit and a de-humidifier, and wherein the processor is further configured to:
(d) when the effective temperature is sufficiently greater than the set point temperature, activate the cooling unit and the de-humidifier.

6. The apparatus of claim 5, wherein:
the environmental unit further comprises a fan;
the plurality of environmental factors include a temperature measurement, a relative humidity measurement, and an air speed measurement; and
the processor is further configured to:
(e) determine the effective temperature from the temperature measurement, the humidity measurement, and the air speed measurement;
(f) activate the fan until the effective temperature is sufficiently decreased with respect to the set point temperature or until the fan reaches a maximum fan speed;
(g) when the effective temperature cannot be sufficiently decreased by activating the fan, activate the de-humidifier until effective temperature is sufficiently decreased with respect to the set point temperature or until the de-humidifier reaches a maximum de-humidifier speed; and
(h) when the effective temperature cannot be sufficiently decreased by activating the fan and the de-humidifier, activate the cooling unit until the effective temperature is sufficiently decreased with respect to the set point temperature.

7. The apparatus of claim 5, wherein:
the environmental unit further comprises a fan;
the plurality of environmental factors include a temperature measurement, a relative humidity measurement, and an air speed measurement; and
the processor is further configured to:
(e) determine the effective temperature from the temperature measurement, the humidity measurement, and the air speed measurement;
(f) activate the de-humidifier until effective temperature is sufficiently decreased with respect to the set point temperature or until the de-humidifier reaches a maximum de-humidifier speed;
(g) when the effective temperature cannot be sufficiently decreased by activating the de-humidifier, activate the fan until the effective temperature is sufficiently decreased with respect to the set point temperature or until the fan reaches a maximum fan speed; and
(h) when the effective temperature cannot be sufficiently decreased by activating the fan and the de-humidifier, activate the cooling unit until the effective temperature is sufficiently decreased with respect to the set point temperature.

8. The apparatus of claim 5, wherein:
the environmental unit further comprises a fan;
the plurality of environmental factors include a temperature measurement, a relative humidity measurement, and an air speed measurement; and
the processor is further configured to:
(e) determine the effective temperature from the temperature measurement, the humidity measurement, and the air speed measurement;
(f) activate the de-humidifier and the fan until effective temperature is sufficiently decreased with respect to the set point temperature or until the de-humidifier reaches a maximum de-humidifier speed and the fan reaches a maximum fan speed; and
(g) when the effective temperature cannot be sufficiently decreased by activating the fan and the de-humidifier, activate the cooling unit until the effective temperature is sufficiently decreased with respect to the set point temperature.

9. The apparatus of claim 1, wherein the processor is further configured to:
(d) obtain a temperature measurement and a relative humidity measurement; and
(e) determine the effective temperature from the temperature measurement and the relative humidity measurement.

10. The apparatus of claim 9, wherein the environmental unit comprises an air flow actuator and wherein the processor is further configured to:
(f) obtain an air speed measurement; and
(g) modify the effective temperature in accordance with the air speed measurement.

11. The apparatus of claim 1, further comprising:
a communications interface that is configured to communicate with a remote sensor; and
wherein the processor is further configured to:
(d) obtain one of the plurality of environmental factors from a remote sensor through the communications interface.

12. The apparatus of claim 11, wherein the communications interface supports a wireless networking protocol.

13. A computer-readable medium having computer-executable instructions that when executed perform:
(a) obtain a plurality of environmental factors
(b) determine an effective temperature from the plurality of environmental factors; and
(c) when the effective temperature is sufficiently different from a set point temperature, activate an environmental unit to change the effective temperature in accordance with the set point temperature.

14. The computer-readable medium of claim 13, further including computer-executable instructions that when executed perform:
(d) when the effective temperature is sufficiently less than the set point temperature, activate a heating unit, wherein the environmental unit comprises the heating unit.

15. The computer-readable medium of claim 14, further including computer-executable instructions that when executed perform:
(e) determine the effective temperature from a temperature measurement and a humidity measurement, wherein the plurality of environmental factors include the temperature measurement and the relative humidity measurement;
(f) activate the humidifier until the effective temperature is sufficiently increased with respect to the set point temperature or until a measured relative humidity is sufficiently stable; and
(g) when the effective temperature cannot be sufficiently increased by activating the humidifier, activate the heating unit until the effective temperature is sufficiently increased with respect to the set point temperature.

16. The computer-readable medium of claim 13, further including computer-executable instructions that when executed perform:
(d) when the effective temperature is sufficiently greater than the set point temperature, activate a cooling unit and a de-humidifier, wherein the environmental unit comprises the cooling unit and the de-humidifier.

17. The computer-readable medium of claim 16, further including computer-executable instructions that when executed perform:
(e) determine the effective temperature from a temperature measurement, a humidity measurement, and an air speed measurement, wherein the plurality of environmental factors include the temperature measurement, the relative humidity measurement, and the air speed measurement;
(f) activate a fan until the effective temperature is sufficiently decreased with respect to the set point temperature or until the fan reaches a maximum fan speed, wherein the environmental unit comprises the fan;
(g) when the effective temperature cannot be sufficiently decreased by activating the fan, activate the de-humidifier until effective temperature is sufficiently decreased with respect to the set point temperature or until the de-humidifier reaches a maximum de-humidifier speed; and
(h) when the effective temperature cannot be sufficiently decreased by activating the fan and the de-humidifier, activate the air conditioning unit until the effective temperature is sufficiently decreased with respect to the set point temperature.

18. The computer-readable medium of claim 16, further including computer-executable instructions that when executed perform:
(e) determine the effective temperature from a temperature measurement, a humidity measurement, and an air speed measurement, wherein the plurality of environmental factors include the temperature measurement, the relative humidity measurement, and the air speed measurement;
(f) activate the de-humidifier until effective temperature is sufficiently decreased with respect to the set point temperature or until the de-humidifier reaches a maximum de-humidifier speed;
(g) when the effective temperature cannot be sufficiently decreased by activating the de-humidifier, activate a fan until the effective temperature is sufficiently decreased with respect to the set point temperature or until the fan reaches a maximum fan speed, wherein the environmental unit further comprises the fan; and
(h) when the effective temperature cannot be sufficiently decreased by activating the fan and the de-humidifier, activate the cooling until the effective temperature is sufficiently decreased with respect to the set point temperature.

19. The computer-readable medium of claim 16, further including computer-executable instructions that when executed perform:
(e) determine the effective temperature from a temperature measurement, a humidity measurement, and an air speed measurement, wherein the plurality of environmental factors include the temperature measurement, the relative humidity measurement, and the air speed measurement;
(f) activate the de-humidifier and a fan until effective temperature is sufficiently decreased with respect to the set point temperature or until the de-humidifier reaches a maximum de-humidifier speed and the fan reaches a maximum fan speed, wherein the environmental unit further comprises the fan; and
(g) when the effective temperature cannot be sufficiently decreased by activating the fan and the de-humidifier, activate the cooling unit until the effective temperature is sufficiently decreased with respect to the set point temperature.

20. The apparatus of claim 3, wherein the processor is further configured to:
(h) delay a predetermined time duration before activating the heating unit.

21. The apparatus of claim 6, wherein the processor is further configured to perform:
(i) delay a predetermined time duration before activating the cooling unit.

22. The apparatus of claim 7, wherein the processor is further configured to perform:
(i) delay a predetermined time duration before activating the cooling unit.

23. The apparatus of claim 8, wherein the processor is further configured to perform:
(h) delay a predetermined time duration before activating the cooling unit.

24. An apparatus comprising:
a wireless communications interface that is configured to communicate with a remote sensor;
a memory;
a processor coupled to the memory and configured to perform:
(a) obtain a temperature measurement and a relative humidity measurement from at least one remote sensor through the wireless communications interface;
(b) determine an effective temperature from the temperature measurement and the relative humidity measurement;
(c) activate a humidifier until the effective temperature is sufficiently increased with respect to a set point temperature or until a measured relative humidity is sufficiently stable; and
(d) when the effective temperature cannot be sufficiently increased by activating the humidifier, activate a heating unit until the effective temperature is sufficiently increased with respect to the set point temperature.

25. An apparatus comprising:
a wireless communications interface that is configured to communicate with a remote sensor;
a memory;
a processor coupled to the memory and configured to perform:
(a) obtain a temperature measurement, a relative humidity measurement, and an air speed measurement from at least one remote sensor through the wireless communications interface;
(b) determine the effective temperature from the temperature measurement, the humidity measurement, and the air speed measurement;
(c) activate a fan until the effective temperature is sufficiently decreased with respect to a set point temperature or until the fan reaches a maximum fan speed;
(d) when the effective temperature cannot be sufficiently decreased by activating the fan, activate a de-humidifier until effective temperature is sufficiently decreased with respect to the set point temperature or until the de-humidifier reaches a maximum de-humidifier speed; and
(e) when the effective temperature cannot be sufficiently decreased by activating the fan and the de-humidifier, activate a cooling unit until the effective temperature is sufficiently decreased with respect to the set point temperature.

26. An apparatus comprising:
a wireless communications interface that is configured to communicate with a remote sensor;
a memory;
a processor coupled to the memory and configured to perform:
(a) obtain a temperature measurement, a relative humidity measurement, and an air speed measurement from at least one remote sensor through the wireless communications interface;
(b) determine the effective temperature from the temperature measurement, the humidity measurement, and the air speed measurement;
(c) activate the de-humidifier until effective temperature is sufficiently decreased with respect to a set point temperature or until the de-humidifier reaches a maximum de-humidifier speed;
(d) when the effective temperature cannot be sufficiently decreased by activating the de-humidifier, activate a fan until the effective temperature is sufficiently decreased with respect to the set point temperature or until the fan reaches a maximum fan speed; and
(e) when the effective temperature cannot be sufficiently decreased by activating the fan and the de-humidifier, activate a cooling unit until the effective temperature is sufficiently decreased with respect to the set point temperature.

27. An apparatus comprising:
a wireless communications interface that is configured to communicate with a remote sensor;
a memory;
a processor coupled to the memory and configured to perform:
(a) obtain a temperature measurement, a relative humidity measurement, and an air speed measurement from at least one remote sensor through the wireless communications interface;
(b) determine the effective temperature from the temperature measurement, the humidity measurement, and the air speed measurement;
(c) activate a de-humidifier and a fan until effective temperature is sufficiently decreased with respect to a set point temperature or until the de-humidifier reaches a maximum de-humidifier speed and the fan reaches a maximum fan speed; and
(e) when the effective temperature cannot be sufficiently decreased by activating the fan and the de-humidifier, activate a cooling unit until the effective temperature is sufficiently decreased with respect to the set point temperature.
